(19) United States
(12) Patent Application Publication
(10) Pub. No.: US 2005/0164830 A1
(43) Pub. Date: Jul. 28, 2005

(54) Hydraulic gear shift arrangement of an automatic transmission for motor vehicles

(76) Inventors: Thilo Schmidt, Meckenbeuren (DE); Stefan Kilian, Friedrichshafen (DE); Matthias Reisch, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/041,719

(22) Filed: Jan. 24, 2005

(30) Foreign Application Priority Data
Jan. 24, 2004 (DE) 10 2004 003 692.6

(51) Int. Cl. B60K 41/02

(52) U.S. Cl. 477/176

(57) ABSTRACT

A hydraulic gear shift arrangement of an automatic transmission for motor vehicles with a hydraulic pump, which transports a hydraulic fluid having a main or system pressure P_{SYS} in a main pressure line to which a lubricating valve (1) and a fluid cooler (16) are connected via a branch line (2). The fluid cooler (16) has a supply line (14) with a supply pressure P_{ZK}, and a return line (17) with a return pressure P_{VK}, and the lubricating valve (1) is connected to both the supply line (14) and the return line (17).

The invention concerns a hydraulic gearshift arrangement of an automatic transmission for motor vehicles according to the preamble of patent claim 1.

Automatic transmissions for motor vehicles are equipped with a hydraulic fluid circulation system, the task is to provide the various parts of the automatic transmission, i.e., the converter, the shifting elements and the gear transmission with pressure fluid, cooling fluid and lubricating oil. For these different tasks, a hydraulic fluid (a so-called ATF fluid) is used, which is brought to system or main pressure by a hydraulic pump and is transported in a main pressure line. From the main pressure line individual fluid streams of differing pressure levels are branched off, which is executed by way of pressure reducer valves and distributing valves.

Among other things, a partial stream is branched off from the main pressure line for the various lubricating points of the automatic transmission, e.g., planetary gears and lamella of the shifting elements. In this, the necessary lubricating pressure is controlled by a central lubricating valve. In most cases, there is also a fluid cooler in the partial stream for lubrication, in which the hydraulic fluid is cooled by means of ambient air or by means of a cooling agent from the cooling circuit of the combustion engine of the motor vehicle. Such a hydraulic fluid circulation system is known from DE-A 39 37 976. In this circulation system, the lubricating valve is arranged behind the fluid cooler in direction of the fluid stream, namely, by the in-line arrangement of a control valve.

In other known hydraulic fluid circulation systems of the Applicant, the central lubricating valve is arranged in the supply of the fluid cooler, i.e., upstream, wherein the stream of lubricating oil exiting the fluid cooler provides the lubricating pressure level. The fluid-sided decrease of pressure in the fluid cooler is dependent upon the fluid temperature, i.e., the viscosity of the hydraulic fluid. In this respect, there is a greater decrease in pressure at lower temperatures, which results overall in a lubricating oil stream with a changeable fluid pressure level.

The present invention is based upon the objective of creating a hydraulic gear shift arrangement in the form stated in the beginning, such that a constant lubricating pressure or a constant lubricating oil stream is achieved.

This objective is attained with the characteristics of patent claim 1.

The invention provides that the pressure in the cooler return, the so-called return pressure, is carried back to the lubricating valve, i.e., the lubricating valve is connected to both the supply and the return of the fluid cooler. Depending upon the design of the lubricating valve and the arrangement of the pressure ports, on one hand, a constant lubricating oil pressure and, on the other hand, a constant lubricating oil stream can be achieved.

In an advantageous embodiment of the invention, the lubricating valve has a valve bore in which a gate valve is displaceably arranged and is weighted by a valve spring. Furthermore, the valve bore has individual toroidal chambers;

a control chamber and spring chamber, which serve as pressure ports for the connection to the supply and return or for the system pressure.

A further object of the invention is the cooler return connected via a control line to the frontal side control space, in which the first piston of the spring-weighted gate valve is accommodated. The return pressure is thereby carried back onto the piston surface of the first piston. The pressure in the control space is determined by the valve spring force. This creates the advantage that downstream of the fluid cooler, i.e., in its return, a constant pressure exists, which is available as constant lubricating pressure to the lubricating points of the automatic transmission.

The lubricating pressure is no longer dependent upon the decrease of pressure in the cooler.

Yet another object of the invention is a pressure relief valve arranged parallel to the cooler. This creates the advantage that the cooler is protected against an inadmissibly high supply pressure, since the supply pressure also increases with an increasing decrease in pressure.

In a further advantageous embodiment of the invention is the control line connected to the return of the return pressure with the frontal side spring chamber of the lubricating valve. Thereby, the return pressure is carried back onto the piston surface of the second piston, which is equal to the piston surface of the first piston. This results in a constant decrease in pressure at the cooler, which is adjusted via the rigidity of the spring of the valve spring, and the piston surfaces. By means of this constant decrease in pressure, the advantage of a constant lubricating oil stream is achieved.

A still further object of the invention, the supply pressure of the cooler is carried onto the piston surface of the second piston and via a pressure compensation line onto the piston surface of the first piston, i.e., into the control space. This creates the advantage that the pressure peaks of the supply pressure are dampened for the protection of the fluid cooler.

Exemplary embodiments of the invention are shown in the drawing, and are explained in more detail in the following, whereby is shown in:

FIG. 1 is a gearshift arrangement for a lubricating valve with constant lubricating pressure;

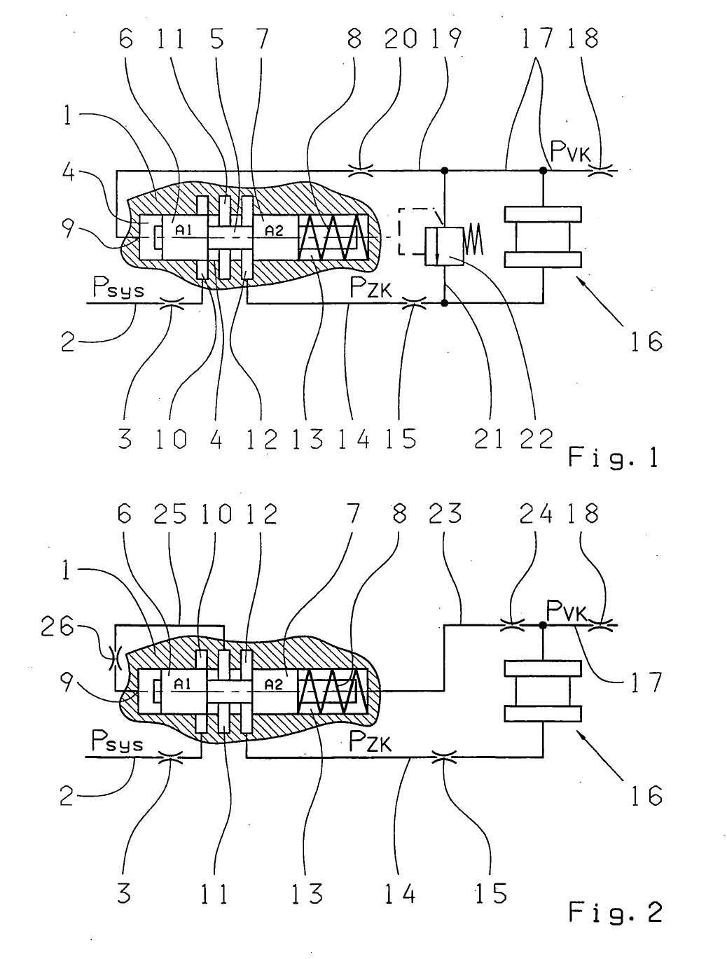

FIG. 2 is a gearshift arrangement for a lubricating valve with a constant stream;

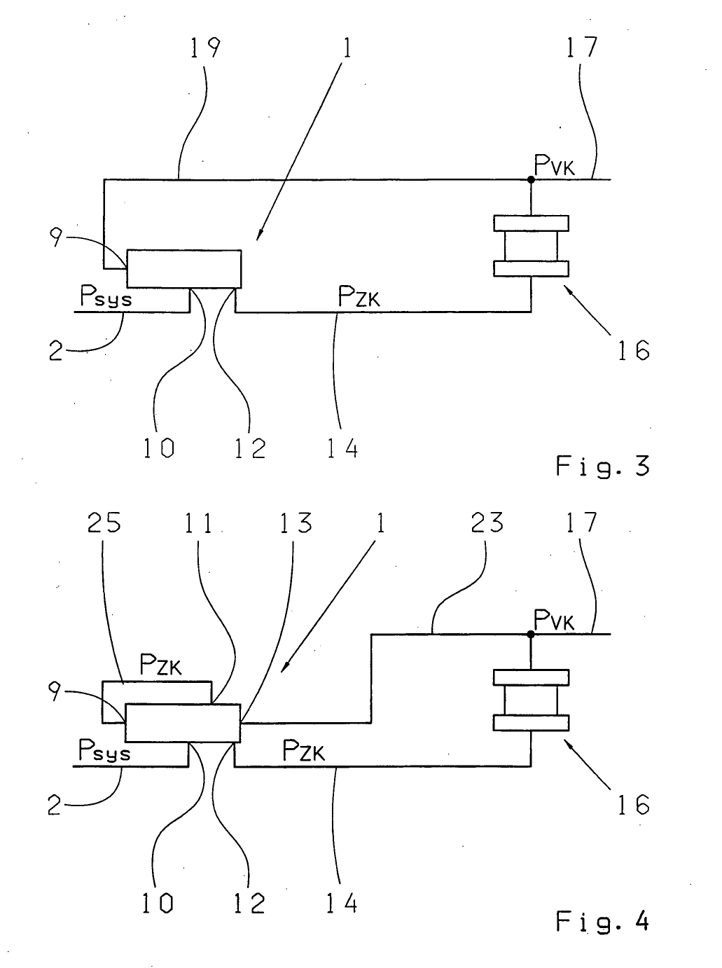

FIG. 3 is a generalized illustration of the exemplary embodiment according to FIG. 1; and

FIG. 4 is a generalized illustration of the exemplary embodiment according to FIG. 2.

FIG. 1 shows a gearshift arrangement of a not completely illustrated hydraulic fluid circulation system of an automatic transmission for a motor vehicle. The hydraulic fluid circulation system has a system pressure P_{sys}, which is generated by a hydraulic pump, which is not shown. From this maximum pressure further pressures, such as the shifting pressure for shifting the shifting elements, or the lubricating pressure for supplying the lubricating points of the automatic transmission, are diverted via valves not shown here.

A central lubricating valve 1 is connected to a main pressure line 2 with a system pressure P_{sys} via a throttle 3. The lubricating valve 1 consists of a valve bore 4, in which a gate valve 5 is displaceably accommodated with two pistons 6, 7, and is weighted by a pressure spring 8. The lubricating valve 1, the housing of which is only partially illustrated in hatched form, has four ports, namely a frontal side control space 9, as well as a first toroidal chamber 10, a second toroidal chamber 1 1, and a third toroidal chamber 12. To the toroidal chamber 10, the main pressure line 2 is connected via the throttle 3. The valve bore 4 ends at the front side in a spring chamber 13, which accommodates the pressure spring 8, which is supported on the one hand at the valve body 1, and on the other hand at the piston 7. From the third toroidal chamber 12 a supply line 14 leads to the fluid cooler 16 via a throttle 15. The lubricating valve 1 is thereby arranged in the supply of the fluid cooler 16. The fluid flowing to the cooler 16 via the supply line 14, flows through the fluid cooler 16, and subsequently enters the return line 17, which, via a further throttle 18, leads to lubricating spots of the automatic transmission, which are not illustrated here, and supplies these, e.g., planetary gears, or lamella of gear boxes, with lubricating oil and cooling fluid. The return line 17 is connected to the control space 9 of the lubricating valve 1 via a control line 19, and a further throttle 20. Parallel to the fluid cooler 16 a pressure relief valve 22 is connected via a bypass line 21.

In the supply line 14 the supply pressure P_{ZK} exists, in the return line 17 the return pressure P_{VK}. The decrease in pressure at the cooler 16 results from the difference Δp=P_{ZK}−P_{VK}. The pressure spring 8 has a spring rigidity C, or a spring force F=C×X resulting therefrom, wherein X is the spring path. In the control space 9, due to the connection via the control line 19, there is the return pressure P_{VK} The piston 6 has a piston surface A1. Therewith the following relationship applies:
P_{VK}=F/A1

The return pressure P_{VK} is therefore determined by the ratio of the spring force F to the piston surface A1, i.e., it is constant. The supply pressure P_{ZK} is, however, variable, since the decrease in pressure Δp at the cooler 16 is temperature variable. The greater the decrease in pressure Δp, the greater the supply pressure P_{ZK}. To protect the cooler 16 from an increased, inadmissible pressure, the pressure relief valve 22 is thus provided, which opens at an inadmissibly high supply pressure P_{ZK}, and relieves the cooler 16.

FIG. 2 shows the lubricating valve 1 in a modified shifting arrangement, wherein in the following, for the same parts, the same reference numbers are used as in FIG. 1. As in the exemplary embodiment according to FIG. 1, the lubricating valve 1 is connected via the first toroidal chamber 10 to the main pressure line 2 via a throttle 3. The fluid cooler 16 is connected with the third toroidal chamber 12 of the lubricating valve 1 via the supply line 14 and a throttle 15, i.e., the lubricating valve 1 is again arranged in the supply of the fluid cooler 16.

The piston 7 has a piston surface A2, which is equal to A1. In contrast to the exemplary embodiment according to FIG. 1, here the return line 17 is connected via a control line 23 and a throttle 24 with the spring chamber 13, i.e., the return pressure P_{VK} is carried back onto the piston surface A2 of the piston 7. Furthermore, the second toroidal chamber 11 is connected to the control chamber 9 via a pressure compensation line 25 and a throttle 26, i.e., the supply pressure P_{ZK} is carried back onto the piston surface A1 of the piston 6. Therefore, the following relationship applies: The decrease in pressure Δp at the cooler 16 results from the ratio of spring force, i.e., force F of the spring 8, and the piston surface A1, or A2.
Δp=F/A1=F/A2

The decrease in pressure Δp at the cooler 16 is therefore constant, and is adjustable via the spring force F, as well as the piston surfaces A1, A2. This also results in a constant flow of lubricating fluid in the return line 17. By the return of the supply pressure P_{ZK}, via the pressure compensation line 25, into the control space 9, pressure peaks of the supply pressure P_{ZK} are dampened, and the fluid cooler 16 is protected.

FIG. 3 shows the exemplary embodiment according to FIG. 1 in a generalized form, wherein the same reference numbers are used for the same parts. The lubricating valve 1 consists of a first pressure port 12, a second pressure port 9, and a system pressure port 10, by means of which it is connected to the main pressure line. The fluid cooler 16 has a supply line 14 with a supply pressure P_{ZK}, and a return line 17 with a return pressure P_{VK}. The lubricating valve 1, on the one hand, is connected to the fluid cooler 16 via the supply line 14, and the first pressure port 12, and on the other hand is connected to the return 17 of the fluid cooler 16 via the second pressure port 9, and a control line 19;

therefore the pressure differential, or decrease in pressure of the fluid cooler 16, is at the lubricating valve 1.

FIG. 4 shows the exemplary embodiment according to FIG. 3 in a generalized form, wherein the same reference numbers are used for the same parts. The lubricating valve 1 is connected to the main pressure line via a system port 10, and consists of a first pressure port 12, a second port 9, and a third pressure port 13, which is connected to the return line 17 of the fluid cooler 16 via a control line 23; the fluid cooler 16, in turn, is connected to the first pressure port 12 of the lubricating valve 1 via a supply line 14. A fourth pressure port 11 of the lubricating valve 1 is connected to the second pressure port 9 via a pressure compensation line 25.

### REFERENCE NUMERALS

1 lubricating valve
2 main pressure line
3 throttle
4 valve bore
5 gate valve
6 1st valve piston
7 2nd valve piston
8 valve spring
9 control space (second pressure port)
10 1st toroidal chamber (system pressure port)
11 2nd toroidal chamber (fourth pressure port)
12 3rd toroidal chamber (first pressure port)
13 spring chamber (third pressure port)
14 supply line
15 throttle
16 fluid cooler
17 return line
18 throttle
19 control line
20 throttle
21 bypass line
22 pressure relief valve
23 control line
24 throttle
25 pressure compensation line
26 throttle

1-12. (canceled)

13. A hydraulic gear shift arrangement of an automatic transmission for motor vehicles with a hydraulic pump, which transports a hydraulic fluid with one of a main or system pressure (P_{sys}) to a main pressure line, to which a lubricating valve (1) and a fluid cooler (16) are connected via a branch line (2), the fluid cooler (16) has a supply line (14) with a supply pressure (P_{ZK}), and a return line (17) with a return pressure (P_{VK}), and in that the lubricating valve (1) is connected to both the supply line (14) and the return line (17).

14. The gear shift arrangement according to claim 13, wherein the lubricating valve (1) is connected to the supply line (14) via a first pressure port (12), and to the return line (17) via a second pressure port (9) and a control line (19).

15. The gear shift arrangement according to claim 13, wherein the lubricating valve (1) is connected to the supply line (14) via a first pressure port (12), and to the return line (17) via a third pressure port (13) and a control line (23).

16. The gear shift arrangement according to claim 15, wherein the lubricating valve (1) has a fourth pressure port (11), which is connected to a second pressure port (9) via a pressure compensation line (25).

17. The gear shift arrangement according to claim 13, wherein the lubricating valve (1) is connected to the branch line (2) via a system pressure port (10).

18. The gear shift arrangement according to claim 13, wherein the lubricating valve (1) consists of a valve bore (4) accommodating a gate valve (5) with coaxially arranged toroidal chambers (10, 11, 12), a frontal side control space (9), and a frontal side spring chamber (13), the gate valve (5) has two valve pistons (6, 7) that slide in the valve bore (4), and is weighted by a valve spring (8) arranged in a spring chamber (13), and in that the first, the fourth, and the fifth pressure ports are formed by the toroidal chambers (12, 11, 10), the second pressure port is formed by the control space (9), and the third pressure port is formed by the spring chamber (13).

19. The gear shift arrangement according to claim 18, wherein a first valve piston (6) has a piston surface A1 in the control space (9), and the pressure spring (8) has a spring force F that acts on the gate valve (5), and in that the pressure in the control space (9) is equal to the return pressure P_{VK}.

20. The gear shift arrangement according to claim 14, wherein a throttle (20) is arranged in a control line (19).

21. The gear shift arrangement according to claim 13, wherein a pressure relief valve (22) is arranged in-line parallel to the fluid cooler (16).

22. The gear shift arrangement according to claim 13, wherein a throttle (15) is arranged in the supply line (14).

23. The gear shift arrangement according to claim 15, wherein a throttle (24) is arranged in the control line (23).

24. The gear shift arrangement according to claim 16, wherein a throttle (26) is arranged in the pressure compensation line (25).
